(19) United States
(12) Patent Application Publication
(10) Pub. No.: US 2026/0343462 A1
(43) Pub. Date: Oct. 29, 2026

(54) ENTITIES AND METHODS FOR ENABLING DUAL RADIO REGISTRATION IN MOBILE NETWORKS

(71) Applicant: HUAWEI TECHNOLOGIES CO., LTD., Shenzhen (CN)

(72) Inventors: Clarissa Marquezan, Munich (DE); Steven James Wenham, Cambridge (GB); Marco Spini, Boulogne Billancourt (FR); Riccardo Trivisonno, Munich (DE); Wint Yi Poe, Munich (DE)

(21) Appl. No.: 19/699,165

(22) Filed: Jun. 5, 2026

Related U.S. Application Data
(63) Continuation of application No. PCT/EP2023/084789, filed on Dec. 7, 2023.

(51) Int. Cl. H04W 60/00; H04W 8/14; H04W 88/06

(52) U.S. Cl. CPC H04W 60/005; H04W 8/14; H04W 88/06

(57) ABSTRACT

A first control plane entity, in particular V-AMF, (130b) of a first mobile network (160b) is configured to obtain roaming Dual Radio, DR, registration information to support a roaming DR registration of a roaming user equipment, UE, (110) in the first mobile network (160b). The roaming DR registration information of the roaming UE (110) is related to a DR capability of the roaming UE (110), wherein the DR capability of the roaming UE (110) defines that the roaming UE (110) has a subscription for a second mobile network (160a) and the roaming UE (110) is capable of being associated with a first and a second access node (120a, b) of the same radio access technology, RAT, type and wherein the first access node (120b) is related to the first mobile network (160b) and the second access node (120a) is related to the second mobile network (160a).

### CROSS-REFERENCE TO RELATED APPLICATIONS

This application is a continuation of International Application No. PCT/EP2023/084789, filed on Dec. 7, 2023, the disclosure of which is hereby incorporated by reference in its entirety.

### TECHNICAL FIELD

The present disclosure relates to wireless communications. More specifically, the present disclosure relates to entities and methods for enabling dual radio registration using the same radio access type in cellular mobile networks.

### BACKGROUND

3GPP TS 23.501 defines for the 5G System Architecture the mechanisms for dual registration for the same UE with a single subscription (e.g. for a single SUPI, therefore a single identification associated with the user equipment) under the mechanisms of ATSSS (Access Technology Steering, Switching, Splitting) when the UE is using one access type that is 3GPP (e.g., a gNB or NR access node) and another access node that is a non-3GPP type of RAT—Radio Access Technology—(e.g., WIFI). It is possible that a UE is registered and being served with one PLMN over one access node of a given RAT type and with another PLMN with the other access node of a different RAT type.

There is another group of technical solutions where dual registration would apply: Multi-USIM (Universal Subscriber Identity Module) as defined in 3GPP 5GS Architecture in TS 23.501. This case defines the situation in which two SIM Cards (i.e., two subscriptions or two USIM or two SUPIs) are used by the same UE, which allows the UE to be registered and served by two different access nodes, one with each USIM. This means that such UE has two different subscriptions (e.g., with different SUPI to identify such UE) and consequently two different registrations. In this case, the two registrations are treated separately, because from the mobile operator perspective they are related to different USIM or SIM cards or SUPI identifications.

The existing mechanisms defined for the 5G System architecture prevent a single UE with a single subscription to be able to be registered and served by two access nodes of the same 3GPP RAT Type (e.g., two gNBs or two NR) from different mobile network operators.

### SUMMARY

It is an objective of the present disclosure to provide improved entities and methods for enabling dual radio registration using the same radio access type in cellular mobile networks.

The foregoing and other objectives are achieved by the subject matter of the independent claims. Further implementation forms are apparent from the dependent claims, the description and the figures.

According to a first aspect a first control plane entity, in particular visiting access management function, V-AMF, of a first mobile network, in particular visiting public land mobile network, V-PLMN, is provided.

The first control plane entity, in particular V-AMF, is configured to obtain roaming Dual Radio, DR, registration information to support a roaming DR registration of a roaming user equipment, UE, in the first mobile network, in particular VPLMN. The roaming DR registration information of the roaming UE is related to a DR capability of the roaming UE, wherein the DR capability of the roaming UE defines that the roaming UE has a subscription for a second mobile network, in particular home public land mobile network, HPLMN, and the roaming UE is capable of being associated with a first and a second access node of the same radio access technology, RAT, type and wherein the first access node is related to the first mobile network, in particular VPLMN, and the second access node is related to the second mobile network, in particular HPLMN. Moreover, the first control plane entity, in particular V-AMF, is configured to determine, based on the roaming DR registration information, whether the roaming UE with DR capability is allowed any of the following: to use resources of the first mobile network, in particular VPLMN; to be associated with the first mobile network, in particular VPLMN, and/or to have DR support in the first mobile network, in particular VPLMN.

Thus, the first control plane entity, in particular V-AMF, according to the first aspect enables the differentiation of a roaming UE using dual NR capability in the first mobile network, in particular VPLMN, wherein dual NR capability denotes that the UE has a single subscription using the two access nodes having the same RAT type and wherein the access nodes are in different mobile networks, namely the first and the second mobile network. The differentiation of the roaming UE from a roaming UE using Dual NR capability provides the technical advantage that the V-AMF can have the proper information to select different NFs (e.g., V-SMF and H-SMFs) that can properly define in later stages the session parametrizations appropriated to dual NR capable UEs. Additionally, because of the proper information to differentiate the roaming UEs, the V-AMF is enabled to properly provide Dual NR related information for other NFs when the UE decides to activate or use the dual NR capability in the VPLMN. Furthermore, another advantage of such differentiation is that the V-AMF is then enabled with the capability to decide and/or prioritize the roaming UEs from a certain HPLMN which may be able to be served first, according with proper agreements among VPLMN and HPLMN.

In this disclosure, the term single subscription is equivalent to any of the following:
The UE (or subscriber) is associated with two different SUPIs or subscription information that are sharing one subscription profile from the same operator.
The UE (or subscriber) is associated with one SUPI or subscription information that is related to one subscription profile from one operator.

In a further possible implementation form, the first control plane entity, in particular V-AMF, is configured to obtain the roaming DR registration information based on any of the following:
obtaining a roaming DR registration indication, where the roaming DR registration indication is indicative of a request for using dual radio capability and/or support for dual radio capability;
obtaining roaming DR support information, wherein the roaming DR support Information defines at least one of: roaming dual radio Capability Information that can be supported by and/or configured for the roaming UE and/or roaming dual radio Capability Information that is in use by the roaming UE or that is associated with the roaming UE at a given point in time, wherein the roaming dual radio Capability Information defines one or more parameters and/or one or more configurations related to the dual radio capability of the roaming UE; and/or
being configured with roaming DR support configuration for the first mobile network, in particular VPLMN, such as VPLMN DNR support configuration and local policies or local configuration, e.g., mappings of RAN entities to geographical areas among other type of mappings, to support the determination whether one or more roaming UE(s) are associable with the DR capability of the UE in the first mobile network, in particular VPLMN, wherein the roaming DR support configuration defines the information that is configured at the first control plane entity, in particular V-AMF, of the first mobile network, in particular VPLMN, and related to the DR capability of one or more roaming UEs with subscription at the second mobile network, in particular HPLMN, that can be associated and/or used by the roaming UE with the DR capability of the roaming UE in the first mobile network, in particular VPLMN. This allows the first control plane entity, in particular V-AMF, to effectively obtain the roaming DR registration information. The term roaming dual radio Capability Information is equivalent to the term roaming DNR Capability Information.

In a further possible implementation form, the first control plane entity, in particular

V-AMF, is configured to obtain the roaming DR registration indication by receiving a message comprising the roaming DR registration indication from the roaming UE. This allows the first control plane entity, in particular V-AMF, to effectively obtain the roaming DR registration information.

In a further possible implementation form, the roaming DR registration indication further comprises:
a roaming dual radio registration type, wherein the roaming dual radio registration type indicates a type of UE registration request, wherein the type of UE registration request indicates the UE requesting the registration has a subscription to the second mobile network, in particular HPLMN, and has the DR capability; and/or
dual radio Capability Information, wherein the dual radio Capability Information defines one or more parameters and/or one or more configurations related to the dual radio capability of the roaming UE. Thus, the roaming DR registration indication may comprise further information. This allows the first control plane entity, in particular V-AMF, to have different alternatives to identify a roaming UE related to roaming DR registration information.

In a further possible implementation form, the first control plane entity, in particular V-AMF, is configured to obtain the roaming DR support information by receiving a message comprising the roaming DR support information from a second control plane entity, in particular a home unified data management, H-UDM entity of the second mobile network, in particular HPLMN. The term roaming DR support information is equivalent to roaming DR support indication. This allows the first control plane entity, in particular V-AMF, to obtain confirmation from the second control plane entity, in particular the H-UDM, whether a roaming UE with DNR capability is allowed to use such DNR Capability at the first mobile network, i.e., VPLMN.

In a further possible implementation form, if the first control plane entity, in particular V-AMF, determines that the roaming UE is not allowed to use resources of the first mobile network, in particular VPLMN, for DR support and/or to be associated with the first mobile network, in particular VPLMN, and/or to have DR support in the first mobile network, in particular VPLMN. This allows the first control plane entity, in particular V-AMF, to control which roaming UEs with DNR Capability can use the VPLMN resources.

In a further possible implementation form, the first control plane entity, in particular V-AMF, is configured to send a registration rejection message to the roaming UE, wherein the registration rejection message comprises an indication that the cause for the registration rejection is related to a lack of DR support for the roaming UE in the first mobile network, in particular VPLMN, wherein DR support defines that a UE with DR capability is allowed to use resources from a mobile network and/or be associated with a mobile network. This allows the first control plane entity, in particular V-AMF, to control which roaming UEs with DNR Capability can use the VPLMN resources and to indicate the V-AMF decisions to the roaming UE.

In a further possible implementation form, the first control plane entity, in particular V-AMF, is configured to send the roaming DR registration information to the second control plane entity, in particular H-UDM, of the second mobile network, in particular HPLMN. This allows the first control plane entity, in particular V-AMF, to obtain confirmation from the second control plane entity, in particular the H-UDM, whether a roaming UE with DNR capability is allowed to use such DNR Capability at the first mobile network, i.e., VPLMN.

In a further possible implementation form, the first control plane entity, in particular V-AMF, is further configured to receive from the second control plane entity, in particular H-UDM, of the second mobile network, in particular HPLMN, information indicative of a registration rejection of the roaming UE related to a lack of DR support for the roaming UE, in case the roaming UE is not allowed any of the following:
to use resources of the first mobile network, in particular VPLMN, for DR support and/or resources of the second mobile network, in particular HPLMN, for DR support,
to be associated with the first mobile network, in particular VPLMN, and/or the second mobile network, in particular HPLMN, for DR support, and/or
to have DR support in the first mobile network, in particular VPLMN, and/or for the second mobile network, in particular HPLMN.

This allows the first control plane entity, in particular V-AMF, to obtain confirmation from the second control plane entity, in particular the H-UDM, whether a roaming UE with DNR capability is allowed to use such DNR Capability at the first mobile network, i.e., VPLMN.

In a further possible implementation form, the first control plane entity, in particular V-AMF, is configured to store Roaming DR Registration Indication and/or Roaming DR Registration Information and/or Roaming DR Support Indication together with a roaming UE identification, for instance, a SUPI or a UE ID. This allows the first control plane entity, in particular V-AMF, to control the association of which roaming UE is allowed to use the DNR Capability in the first mobile network as well as the information (e.g., parametrization) that is associated with such permission.

In a further possible implementation form, the first control plane entity, in particular

V-AMF, is further configured to provide the roaming dual radio, DR, information to the roaming UE, wherein the roaming dual radio information defines the one or more parameters related to the dual radio capability of the roaming UE to be used by and/or associated with the roaming UE, in particular as part of a registration acceptance message. This allows the first control plane entity, in particular V-AMF, to control which roaming UEs with DNR Capability can use the VPLMN resources and to indicate the V-AMF decisions to the roaming UE.

According to a second aspect a method for operating a first control plane entity, in particular V-AMF, for a first mobile network, in particular VPLMN, is provided. The method according to the second aspect comprises the steps of:
obtaining roaming Dual Radio, DR, registration information to support a roaming DR registration of a roaming user equipment, UE, in the first mobile network, in particular VPLMN, wherein the roaming DR registration information of the roaming UE is related to a DR capability of the roaming UE, wherein the DR capability of the roaming UE defines that the roaming UE has a subscription for a second mobile network, in particular HPLMN, and the roaming UE is capable of being associated with a first and a second access node of the same radio access technology, RAT, type and wherein the first access node is related to the first mobile network, in particular VPLMN, and the second access node is related to the second mobile network, in particular HPLMN; and
determining, based on the roaming DR registration information, whether the roaming UE with DR capability is allowed any of the following: to use resources of the first mobile network, in particular VPLMN, for DR support; to be associated with the first mobile network, in particular VPLMN, and/or to have DR support in the first mobile network, in particular VPLMN.

Thus, the method according to the second aspect enables the differentiation of the roaming UE from a roaming UE using Dual NR capability and provides the technical advantage that the V-AMF can have the proper information to select different NFs (e.g., V-SMF and H-SMFs) that can properly define in later stages the session parametrizations appropriated to dual NR capable UEs. Additionally, because of the proper information to differentiate the roaming UEs, the V-AMF is enabled to properly provide Dual NR related information for other NFs when the UE decides to activate or use the dual NR capability in the VPLMN. Furthermore, another advantage of such differentiation is that the V-AMF is then enabled with the capability to decide and/or prioritize the roaming UEs from a certain HPLMN which may be able to be served first, according with proper agreements among VPLMN and HPLMN.

The method according to the second aspect can be performed by the first control plane entity, in particular V-AMF, according to the first aspect. Thus, further features of the method according to the second aspect result directly from the functionality of the first control plane entity according to the first aspect as well as its different implementation forms described above and below.

According to a third aspect a second control plane entity, in particular H-UDM, of a second mobile network, in particular H-PLMN, is provided. The second control plane entity, in particular H-UDM, is configured to obtain roaming Dual Radio, DR, registration information to support a roaming DR registration of a roaming user equipment, UE, in a first mobile network, in particular VPLMN, and/or a DR support configuration associated with the roaming UE. The roaming DR registration information is related to a DR capability of the roaming UE, wherein the DR capability of the roaming UE defines that the roaming UE has a subscription for the second mobile network, in particular HPLMN, and is capable of being associated with a first and a second access node of the same radio access technology, RAT, type and wherein the first access node is related to the first mobile network, in particular VPLMN, and the second access node is related to the second mobile network, in particular HPLMN. The DR support configuration defines information that is configured at and/or available to, in particular can be obtained by the second control plane entity by means of receiving it from other control plane entities of the second mobile network, the second control plane entity, in particular H-UDM, of the second mobile network, in particular HPLMN, and related to the DR capability of one or more roaming UEs with subscription at the second mobile network, in particular HPLMN, that can be associated and/or used by the roaming UE with the DR capability of the roaming UE in the second mobile network, in particular HPLMN, and/or in the first mobile network, in particular VPLMN. The second control plane entity, in particular H-UDM, is further configured to determine, based on the roaming DR registration information and/or the DR support configuration, whether the roaming UE with DR capability is allowed any of the following: to use resources of the first mobile network, in particular VPLMN, for DR support and/or the second mobile network, in particular HPLMN, for DR Support; to be associated with the first mobile network, in particular VPLMN, and/or the second mobile network, in particular HPLMN, for DR Support; and/or to have DR support in the first mobile network, in particular VPLMN, and/or the second mobile network, in particular HPLMN.

Thus, the second control plane entity, in particular H-UDM, according to the third aspect (together with the first control plane entity, in particular V-AMF) enables the differentiation of a roaming UE using dual NR capability in the first mobile network, in particular VPLMN, wherein dual NR capability denotes that the UE has a single subscription using the two access nodes having the same RAT type and wherein the access nodes are in different mobile networks, namely the first and the second mobile network.

The differentiation of the roaming UE from a roaming UE using Dual NR capability provides the technical advantage that the H-UDM can have the proper information to define the parametrization that should be used for such roaming UE with CNR capability in later stages, when the UE requests the session parametrizations appropriated to dual NR capable UEs. Additionally, because of the proper information to differentiate the roaming UEs, the H-UDM is enabled to properly provide Dual NR related information for other NFs when the UE decides to activate or use the dual NR capability in the VPLMN. Furthermore, another advantage of such differentiation is that the H-UDM is then enabled with the capability to decide and/or prioritize the roaming UEs (with or without DNR Capability) requesting the registration at a certain VPLMN which may be able to be served by the VPLMN (with or without the DNR Capability), according with proper agreements among VPLMN and HPLMN.

In a further possible implementation form, the second control plane entity, in particular H-UDM, is configured to receive the roaming DR registration information from a first control plane entity, in particular V-AMF, of the first mobile network, in particular VPLMN. This allows the second control plane entity, in particular H-UDM, to control which roaming UEs with DNR Capability can use the VPLMN resources.

In a further possible implementation form, the second control plane entity, in particular H-UDM, is configured to send to the first control plane entity, in particular V-AMF, of the first mobile network, in particular VPLMN, information indicative of a cause of a registration rejection of the roaming UE, in case the roaming UE is not allowed to use resources of the first mobile network, in particular VPLMN, for DR support; to be associated with the first mobile network, in particular VPLMN, and/or to have DR support in the first mobile network, in particular VPLMN. This allows the second control plane entity, in particular H-UDM, to control which roaming UEs with DNR Capability can use the VPLMN resources and to indicate to first control plane entity, in particular V-AMF, the H-UDM decisions.

In a further possible implementation form, the second control plane entity, in particular H-UDM, is configured to determine roaming DR support information and to send the roaming DR support information to a first control plane entity, in particular V-AMF, of the first mobile network, in particular VPLMN. This allows the second control plane entity, in particular H-UDM, to define the parametrization that a roaming UEs with DNR Capability can use at the VPLMN and to indicate to first control plane entity, in particular V-AMF, the H-UDM decisions.

According to a fourth aspect a method for operating a second control plane entity, in particular H-UDM, of a second mobile network, in particular HPLMN, is provided. The method according to the fourth aspect comprises:
obtaining roaming Dual Radio, DR, registration information to support a roaming DR registration of a roaming user equipment, UE, in a first mobile network, in particular VPLMN, and/or a DR support configuration associated with the roaming UE, wherein the roaming DR registration information is related to a DR capability of the roaming UE, wherein the DR capability of the roaming UE defines that the roaming UE has a subscription for the first mobile network, in particular VPLMN, and is capable of being associated with a first and a second access node of the same radio access technology, RAT, type and wherein the first access node is related to the first mobile network, in particular VPLMN, and the second access node is related to the second mobile network, in particular HPLMN, and wherein the DR support configuration defines information that is configured at and/or available to (in particular can be obtained by the second control plane entity, in particular H-UDM, by means of receiving it from other control plane entities of the second mobile network, in particular HPLMN) the second control plane entity, in particular H-UDM, of the second mobile network, in particular HPLMN, and related to the DR capability of one or more roaming UEs with subscription at the second mobile network, in particular HPLMN, that can be associated and/or used by the roaming UE with the DR capability of the roaming UE in the second mobile network, in particular HPLMN, and/or in the first mobile network, in particular VPLMN; and
determining, based on the roaming DR registration information and/or the DR support configuration, whether the roaming UE with DR capability is allowed any of the following: to use resources of the first mobile network, in particular VPLMN, for DR support and/or the second mobile network, in particular HPLMN, for DR Support; to be associated with the first mobile network, in particular VPLMN, and/or the second mobile network, in particular HPLMN, for DR Support; and/or to have DR support in the first mobile network, in particular VPLMN, and/or the second mobile network, in particular HPLMN.

The method according to the fourth aspect can be performed by the second control plane entity, in particular H-UDM, according to the third aspect. Thus, further features of the method according to the fourth aspect result directly from the functionality of the second control plane entity according to the third aspect as well as its different implementation forms described above and below.

The differentiation of the roaming UE from a roaming UE using Dual NR capability provides the technical advantage that the H-UDM can have the proper information to define the parametrization that should be used for such roaming UE with CNR capability in later stages, when the UE requests the session parametrizations appropriated to dual NR capable UEs. Additionally, because of the proper information to differentiate the roaming UEs, the H-UDM is enabled to properly provide Dual NR related information for other NFs when the UE decides to activate or use the dual NR capability in the VPLMN. Furthermore, another advantage of such differentiation is that the H-UDM is then enabled with the capability to decide and/or prioritize the roaming UEs (with or without DNR Capability) requesting the registration at a certain VPLMN which may be able to be served by the VPLMN (with or without the DNR Capability), according with proper agreements among VPLMN and HPLMN.

According to a fifth aspect a user equipment, UE, for using a dual radio, DR, capability in a first mobile network, in particular VPLMN, is provided. The UE is configured to provide a roaming DR registration indication to a first control plane entity, in particular V-AMF of the first mobile network, in particular VPLMN. The roaming DR registration indication is related to a DR capability of the UE, wherein the DR capability of the UE defines that the UE has a subscription for a second mobile network, in particular HPLMN, and is capable of being associated with a first and a second access node of the same radio access technology, RAT, type and wherein the first access node is related to the first mobile network, in particular VPLMN, and the second access node is related to the second mobile network, in particular HPLMN. Moreover, the UE is configured to obtain from the first control plane entity, in particular V-AMF, of the first mobile network, in particular VPLMN, roaming DR information, wherein the roaming DR information defines one or more parameters related to the DR capability of the UE to be used by and/or associated with the UE.

The differentiation of the roaming UE from a roaming UE using Dual NR capability provides the technical advantage that the roaming UE with DNR Capability can have the proper information to identify whether it is allowed and capable to activate and/or use the DNR Capability at the VPLMN. Additionally, the roaming UE with DNR Capability is enabled to have the proper information to define in later stages the session parametrizations appropriated to dual NR capable UEs.

According to a sixth aspect a method for operating a user equipment, UE, for using a dual radio, DR, capability in a first mobile network, in particular VPLMN, is provided. The method according to the sixth aspect comprises: providing a roaming DR registration indication to a first control plane entity, in particular V-AMF, of the first mobile network, in particular VPLMN, wherein the roaming DR registration indication is related to a DR capability of the UE, wherein the DR capability of the UE defines that the UE has a subscription for a second mobile network, in particular HPLMN, and is capable of being associated with a first and a second access node of the same radio access technology, RAT, type and wherein the first access node is related to the first mobile network, in particular VPLMN, and the second access node is related to the second mobile network, in particular HPLMN; and
obtaining from the first control plane entity, in particular V-AMF, of the first mobile network, in particular VPLMN, roaming, DR, information, wherein the roaming, DR, information defines one or more parameters related to the DR capability of the UE to be used by and/or associated with the UE.

The method according to the sixth aspect can be performed by the UE according to the fifth aspect. Thus, further features of the method according to the sixth aspect result directly from the functionality of the UE according to the fifth aspect as well as its different implementation forms described above and below.

According to a seventh aspect, a computer program product is provided, comprising a computer-readable storage medium for storing a program code which causes a computer or a processor to perform the method according to the second aspect, the method according to the fourth aspect, or the method according to the sixth aspect, when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows a schematic diagram illustrating a mobile telecommunication system comprising a UE according to an example with dual radio support by entities of a home PLMN and entities of a visiting PLMN;

FIGS. 2a-f show schematic diagrams illustrating different scenarios for dual radio support of a UE according to an example by entities of a home PLMN and entities of a visiting PLMN;

FIG. 3 is a signalling diagram illustrating interactions between a UE, entities of a visiting PLMN, including a first control plane entity, as well as entities of a home PLMN, including a second control plane entity, according to an example for providing dual radio support to the UE;

FIG. 4 is a signalling diagram illustrating interactions between a UE, entities of a visiting PLMN, including a first control plane entity, as well as entities of a home PLMN, including a second control plane entity, according to a further example for providing dual radio support to the UE;

FIG. 5 is a flow diagram illustrating a method for operating a first control plane entity, in particular a V-AMF, according to an example;

FIG. 6 is a flow diagram illustrating a method for operating a second control plane entity, in particular a H-UDM, according to an example; and

FIG. 7 is a flow diagram illustrating a method for operating a UE according to an example.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. Moreover, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

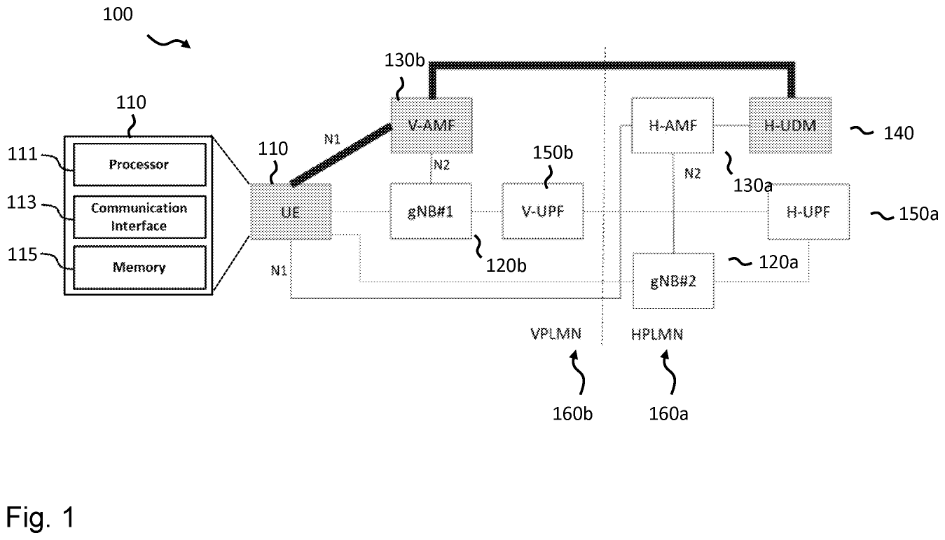

FIG. 1 shows a schematic diagram illustrating a mobile telecommunication system 100 comprising at least one user equipment, UE, 110 being provided with dual radio support of the same RAT type, for instance, the 5G RAT, by a home PLMN, HPLMN, 160a and a visiting PLMN, VPLMN, 160b. In an embodiment, the mobile telecommunication system 100 is a 3rd Generation Partnership Project (3GPP) mobile telecommunication system 100.

The HPLMN 160a comprises or is associated with a plurality of first access nodes or base stations of the same RAT type, such as the first access node 120a, and a plurality of control plane entities, including a home AMF, H-AMF, 130a, a home UDM, H-UDM, 140 and a home UPF, H-UPF 150a. The VPLMN 160b comprises or is associated with a plurality of second access nodes or base stations of the same RAT type as the first access node 120a of the HPLMN 160a, such as the second access node 120b, and a plurality of control plane entities, including a visiting AMF, V-AMF, 130b, and a visiting UPF, V-UPF 150b. As will be appreciated, the HPLMN 160a and the VPLMN 160b may comprise further entities in addition to the entities illustrated in FIG. 1 for operating as a HPLMN and a VPLMN, respectively. For instance, like the HPLMN 160a the VPLMN 160b may comprise a UDM, which, however, is of less relevance for the embodiments disclosed herein.

As illustrated in FIG. 1, the UE 110 may comprise a processing circuitry, e.g. one or more processors 111 and a communication interface 113. The processing circuitry 111 may be implemented in hardware and/or software. The hardware may comprise digital circuitry, or both analog and digital circuitry. Digital circuitry may comprise components such as application-specific integrated circuits (ASICs), field-programmable gate arrays (FPGAs), digital signal processors (DSPs), or one or more general-purpose processors. Moreover, the UE 110 may comprise a memory 115 configured to store executable program code which, when executed by the processing circuitry 111, causes the UE 110 to perform the functions and operations described herein.

Likewise, the V-AMF 130b of the VPLMN 160b may be implemented in hardware and/or software, for instance, in the form of network functions of the VPLMN 160b. The hardware may comprise digital circuitry, or both analog and digital circuitry. Digital circuitry may comprise components such as application-specific integrated circuits (ASICs), field-programmable gate arrays (FPGAs), digital signal processors (DSPs), or one or more general-purpose processors. Moreover, the V-AMF 130b may be configured to store or comprise executable program code which, when executed causes the V-AMF 130b and/or to perform the functions and operations described herein.

Likewise, the H-UDM 140 and the H-AMF 130a of the HPLMN 160a may be implemented in hardware and/or software, for instance, in the form of network functions of the HPLMN 160a. The hardware may comprise digital circuitry, or both analog and digital circuitry. Digital circuitry may comprise components such as application-specific integrated circuits (ASICs), field-programmable gate arrays (FPGAs), digital signal processors (DSPs), or one or more general-purpose processors. Moreover, the H-UDM 140 and/or the H-AMF 130a may be configured to store or comprise executable program code which, when executed causes the H-UDM 140 and/or the H-AMF 130a to perform the functions and operations described herein.

If any mechanism were available to enable the usage and/or association of dual NR paths by a UE (which currently there is none), the NFs in the VPLMN would treat a UE in roaming associated with a single new radio, NR, capability (e.g., a UE that can only be associated—e.g., registered-with one single Access Node of the same RAT technology) in the same way as a UE enabled with dual NR capability. This means that the same QoS policy agreements that would normally apply to normal roaming UEs, would also apply to a UE roaming using Dual NR.

In the case of a H-SMF supporting the usage of the two NR paths, may try to request from V-SMF specific QoS policies. However, current existing mechanisms in 5GS would prevent the NFs in the VPLMN to make a differentiation if the roaming UE is a normal roaming UE (e.g., that is using only one NR path) or if this is a UE with dual NR in roaming at the VPLMN. This is associated with several disadvantages. If there is no registration differentiation at the V-PLMN, an application (e.g., XR applications) will have a very unstable “leg” of the dual NR path via the V-PLMN, if accepted, due to the fact that dual NR UE in roaming is treated in the same way that any other roaming UE. There is no change on QoS handling and no impact for the V-PLMN, however, there is also zero guarantees to support in V-PLMN a proper usage of ATSSS mechanisms for the sessions of the UE with dual NR via HPLMN and VPLMN. If there is no differentiation of roaming registrations and operators just agree to increase QoS parameters for *ANY* Home Routed Roaming sessions, applications (such as XR) can use Dural NR steering with some guarantees that QoS in both paths will at least be the same. Moreover, any Home Routed Roaming session could request stringent QoS support, reducing the scalability of V-PLMN for serving roaming users.

Embodiments disclosed herein enhance the registration mechanisms of the current 5GS architecture at the VPLMN 160b to enable the differentiation of a roaming UE 110 using dual NR capability in the VPLMN 160b, wherein dual NR capability denotes that the UE 110 has a single subscription using the two NR access nodes 120a, b having the same RAT type and wherein one NR node 120b is in the HPLMN 160a and the other NR node 120a is in the VPLMN 160b.

Thus, embodiments disclosed herein address the registration of the UE 110, generally the first step that needs to be performed by the UE 110 in order to be associated and/or use and/or being served by the HPLMN 160a and the VPLMN 160b. More specifically, embodiments disclosed herein enhance the VPLMN awareness for supporting the UE 110 with DNR capability (having a subscription for the HPLMN 160a), where the term DNR capability is equivalent to the term DR capability. According to embodiments disclosed herein the conventional interactions between the UE 110 and the V-AMF 130b (or a different first control plane entity of the VPLMN 160b) are extended to enable the UE 110 to signal to the V-AMF 130b that the DNR capability is intended to be used or activated or supported by the UE 110 when using services of the VPLMN 160b. Moreover, embodiments disclosed herein extend the interactions between the V-AMF 130b (or a different first control plane entity of the VPLMN 160b) and the H-UDM 140 (or a different second control plane entity of the HPLMN 160a) in order to allow the V-AMF 130b to signal to the H-UDM 140 that the V-AMF 130b is performing the UE registration procedure of the roaming UE 110, and that the registration at the VPLMN 160b for the roaming UE 110 is related to the DNR. This allows the H-UDM 140 to perform further checks and allow or restrict any parametrization of the UE 110 related to DNR Capability.

More specifically, a first control plane entity 130b, in particular the V-AMF 130b, is configured to obtain roaming Dual Radio, DR, registration information to support a roaming DR registration of the UE 110 in the VPLMN 160b. The roaming DR registration information of the roaming UE 110 is related to a DR capability of the roaming UE 110, wherein the DR capability of the roaming UE 110 defines that the roaming UE 110 has a subscription for the HPLMN 160a and the roaming UE 110 is capable of being associated with the first and a second access node 120a, b of the same RAT type and wherein the first access node 120a is related to, i.e. a part of the VPLMN 160b and the second access node 120b is related to, i.e. a part of the HPLMN 160a. Moreover, the first control plane entity 130b, in particular V-AMF 130b, is configured to determine, based on the roaming DR registration information, whether the roaming UE 110 with DR capability is allowed any of the following: to use resources of the VPLMN 160b; to be associated with the VPLMN 160b, and/or to have DR support in the VPLMN 160b.

Moreover, a second control plane entity 140, in particular the H-UDM 140, is configured to obtain roaming Dual Radio, DR, registration information to support a roaming DR registration of the roaming UE 110 in the VPLMN 160b, and/or a DR support configuration associated with the roaming UE 110. The roaming DR registration information is related to a DR capability of the roaming UE 110, wherein, as already described above, the DR capability of the roaming UE 110 defines that the roaming UE 110 has a subscription for the HPLMN 160a and is capable of being associated with a first and a second access node 120a, b of the same RAT type and wherein the first access node 120b is related to the VPLMN 160b and the second access node 120a is related to the HPLMN 160a. The DR support configuration defines information that is configured at and/or available to, in particular can be obtained by the H-UDM 140 by means of receiving it from other control plane entities of the HPLMN 160a, the H-UDM 140 of the HPLMN 160a and related to the DR capability of one or more roaming UEs with subscription at the HPLMN 160a that can be associated and/or used by the roaming UE 110 with the DR capability of the roaming UE 110 in the HPLMN 160a and/or in the VPLMN 160b. The second control plane entity 140, in particular H-UDM 140, is further configured to determine, based on the roaming DR registration information and/or the DR support configuration, whether the roaming UE 110 with DR capability is allowed any of the following: to use resources of the VPLMN 160b for DR support and/or the HPLMN 160a for DR Support; to be associated with the VPLMN 160b and/or the HPLMN 160a for DR Support; and/or to have DR support in the VPLMN 160b and/or the HPLMN 160a.

Moreover, the UE 110 with DR capability is configured to provide a roaming DR registration indication to the first control plane entity 130b, in particular the V-AMF 130b of the VPLMN 160b. The roaming DR registration indication is related to the DR capability of the UE 110, wherein the DR capability of the UE 110 defines that the UE 110 has a subscription for the HPLMN 160a, and is capable of being associated with the first and a second access node 120a, b of the same RAT type and wherein the first access node 120b is related to the VPLMN 160b and the second access node 120a is related to the HPLMN 160a. Moreover, the UE 110 is configured to obtain from the first control plane entity 130b, in particular V-AMF 130b, roaming DR information, wherein the roaming DR information defines one or more parameters related to the DR capability of the UE 110 to be used by and/or associated with the UE 110.

Before describing more detailed embodiments of the first control plane entity 130b, in particular V-AMF 130b, the second control plane entity 140, in particular the H-UDM 140, and the UE 110, in the following some technical background as well as definitions and terminology will be introduced making use of one or more of the following abbreviations/acronyms:
5th Generation 5G
Control Plane CP
Core Network CN
Radio Access Technology RAT
Access Traffic Steering, Switching, Splitting ATSSS
Universal Subscriber Identity Module USIM
Multi Universal Subscriber Identity Module M-USIM/MUSIM
Subscriber Identity/Identification Module SIM
Public Land Mobile Network PLMN
Home Public Land Mobile Network H-PLMN/HPLMN
Visiting Public Land Mobile Network V-PLMN/VPLMN
User Equipment UE
Network Function NF
Unified Data Management UDM
Access Management Function AMF
New Radio NR
Terrestrial Network TN
Non-Terrestrial-Network NTN
Satellite SAT
Low Earth Orbit LEO
Medium Earth Orbit MEO
Geostationary Orbit GEO
Other Satellite OTHERSAT
Dual NR DNR
Unified Data Repository UDR
Service Level Agreement SLA

Embodiments disclosed herein are based on the 5G network architecture defined by 3GPP and documented in TS 23.501. Specifically, the embodiments focus on extensions related to the AMF, UDM, UE, defined mainly in the 3GPP TS 23.501 and TS 23.502 specifications. “Roaming UE” and “UE” are interchangeably used as synonyms herein.

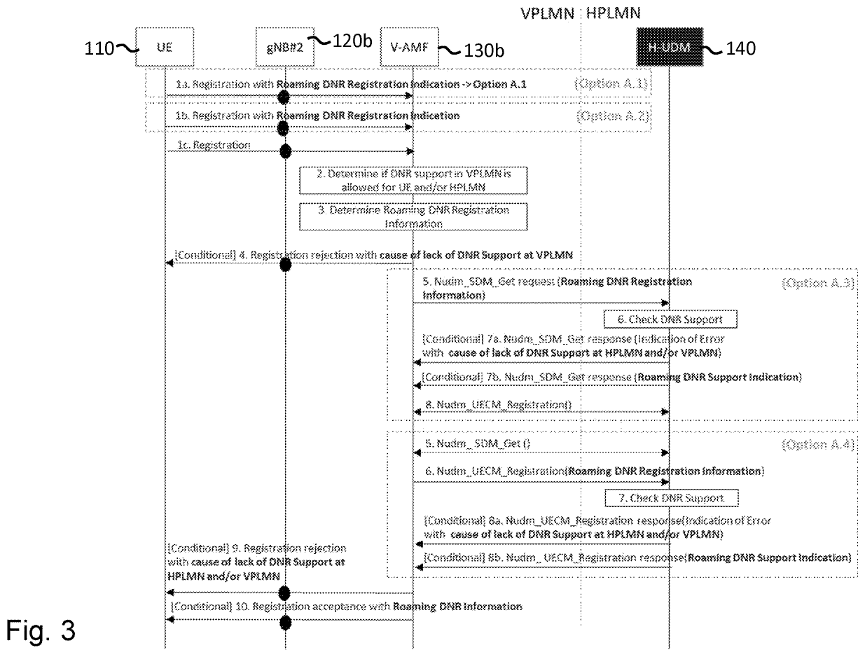

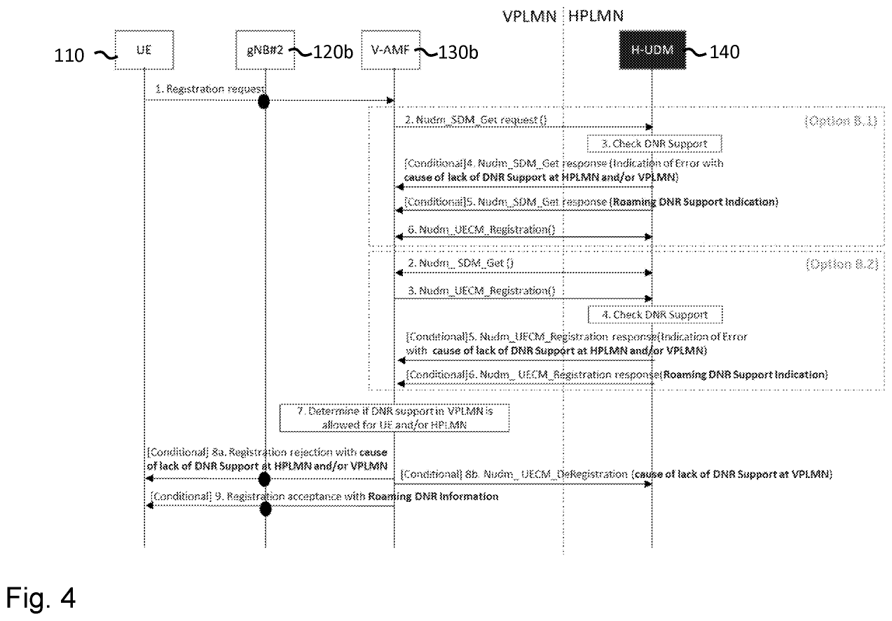

Further below two main embodiments are described in the context of FIGS. 3 and 4 for enabling VPLMN registration with differentiation of the roaming UE 110 with DNR capability, namely (a) a Roaming UE Based Indication of Roaming DNR Registration and (b) a H-UDM Based Indication of Roaming DNR Registration.

The Roaming UE Based Indication of Roaming DNR Registration embodiment is based on the idea that the UE 110 sends (and/or provides) to the V-AMF 130b the indication of a registration request associated with a DNR Capability of the UE 110. Based on this information the V-AMF 130b performs VPLMN checks as well as interacts further with HPLMN entities (e.g., the H-UDM 140) in order to establish (or determine or analyze) whether the UE registration with DNR Capability can be accepted at the VPLMN 160b.

The H-UDM Based Indication of Roaming DNR Registration embodiment is based on the idea that the H-UDM 140 sends (and/or provides) to the V-AMF 130b the indication of a registration request associated with a DNR Capability of a roaming UE 110. Based on this information the V-AMF 130b performs VPLMN checks as well as interacts further with HPLMN entities (e.g., the H-UDM 140) in order to establish (or determine or analyze) whether the UE registration with DNR Capability can be accepted at the VPLMN 160b.

In this disclosure, the information listed below is defined and their usage is listed in the description of the possible options of procedures as detailed in later parts of the text.

As used herein “Roaming DNR Registration Information” or “Roaming DR Registration Information” may include any of the following:

Dual NR UE Capable: This information can be implemented as a configuration flag in the UE 110.

Identification of roaming UE 110.

Identification of VPLMN 160b.

Identification of one or more Visible and/or reachable VPLMNs 160b.

RAT type of access nodes 120b visible and/or reachable at the VPLMN 160b, where for instance examples of possible parameters are any of the following: terrestrial gNB, NR satellite access node with NR(LEO) RAT Type; NR satellite access node with NR(MEO) RAT Type, NR satellite access node with NR(GEO) RAT Type, NR satellite access node with NR(OTHERSAT).

Dual NR radio capability information: define the radio parameters that can be used by the UE 100 with the DNR Capability.

Description and/or identification of the region and/or area and/or location at VPLMN 160b, where the UE 110 requested the registration and/or where the UE 110 is associated with the access node 120b of the VPLMN 160b.

As used herein, “Roaming DNR Registration Indication” or “Roaming DR Registration Indication” comprises any of the following:

Roaming registration type.

Roaming DNR Capability Information.

UE identification.

Dual NR UE Capable.

HPLMN identification (e.g., PLMN ID).

VPLMN identification (e.g., PLMN ID).

Identification of one or more visible and/or reachable VPLMNs by the UE 110.

Identification of the access node of NR RAT Type associated with the UE 110 in VPLMN 160b.

RAT Type of access node 120b associated with the UE 110 in VPLMN 160b.

Description and/or identification of the region and/or area and/or location at VPLMN 160b, where the UE 110 requested the registration and/or where the UE 110 is associated with the access node 120b of the VPLMN 160b.

As used herein, “VPLMN DNR Support Configuration” or “VPLMN DR Support Configuration” or “roaming DR Support Configuration” defines the information (and/or parameters and/or configuration) that has been agreed between the HPLMN 160a and the VPLMN 160b in order to support DNR Capability for one or more roaming UEs from the HPLMN 160a. The VPLMN DNR Support Configuration comprises any of the following information:

HPLMN identification (e.g., PLMN ID) with which the VPLMN 160b has an DNR roaming agreement.

List of identification of the roaming UEs 110 with DNR Capability from HPLMN 160a (e.g., identified by one or more PLMN ID) that are allowed to use and/or activate and/or support such capability at the VPLMN 160b (e.g., identified by a one or more PLMN ID).

List of identification of the roaming UEs 110 with DNR Capability from HPLMN 160a (e.g., identified by one or more PLMN ID) that are restricted to use and/or activate and/or support such capability at the VPLMN 160b (e.g., identified by a one or more PLMN ID).

Indication whether any UE 110 associated with HPLMN 160a are allowed to use and/or activate and/or support such capability at the VPLMN 160b (e.g., identified by a one or more PLMN ID).

Indication whether any UE 110 associated with HPLMN 160a are restricted to use and/or activate and/or support such capability at the VPLMN 160b (e.g., identified by a one or more PLMN ID).

One or more description and/or access node RAT Types that are allowed to be associated with DNR Capability at VPLMN 160b by roaming UEs 110 from HPLMN 160a.

One or more description and/or access node RAT Types that are restricted to be associated with DNR Capability at VPLMN 160b by roaming UEs 110 from the HPLMN 160a.

Mapping per UE identification of one or more description and/or access node RAT Types that can be allowed and/or restricted to be used at VPLMN 160b by the UE 110 with DNR Capability.

Description and/or identification of the region and/or area and/or location at VPLMN 160b, where the DNR Capability can be supported for the one or more roaming UE(s) 110 from the HPLMN 160a.

The “Roaming DNR Information” or “Roaming DR Information” may comprise any of the following:

The list of (the one or more) allowed and/or available and/or restricted VPLMNs 160b (e.g., identified by the PLMN ID) that the UE 110 can be associated with the DNR capability.

List (or one or more) regions (or spatial area or location) allowed and/or restricted in the VPLMN 160b that a UE 110 can use the DNR Capability. Such regions could be identified and/or described in any of the possible formats: cell identification, tracking area identification, street description, geo-coordinates, latitude and longitude coordinates.

List of candidates and/or selectable and/or eligible VPLMNs 160b for DNR Capability use: This information may define a subset of VPLMNs from the allowed list of VPLMNs that can be actually used by the UE 110 with the DNR Capability. In this sense, this defines the possible selected or candidate VPLMNs.

List of allowed and/or restricted access types of NR RAT Type associated with the DNR Capability at the VPLMN 160b. Examples of parameters (or combinations or values) are any of the following: gNBs (i.e., access nodes of NR RAT Type). non-terrestrial access node (NR Satellite access associated with any of the following: NR(LEO) RAT Type, NR(MEO) RAT Type, NR(GEO) RAT Type, NR(OTHERSAT) RAT Type.

VPLMN registration information related to DNR Capability (or Secondary Registration Information), which may be comprised of any of the following:
Identification and/or definition of a secondary registration.
VPLMN identification (e.g., PLMN ID of VPLMN).
NR node associated with the secondary registration information.
V-AMF information (e.g., NF ID and/or service information and/or NF address and/or NF service endpoint information) associated with one NR node serving UE.
Identification of the access node of NR RAT type serving the UE 110 in VPLMN 160b.
Identification of type of access node (e.g., terrestrial or non-terrestrial) in VPLMN 160b.
Identification of non-terrestrial access node NR RAT Type in VPLMN 160b (e.g., NR(LEO) RAT Type, NR(MEO) RAT Type, NR(GEO) RAT Type, NR(OTHERSAT) RAT Type).

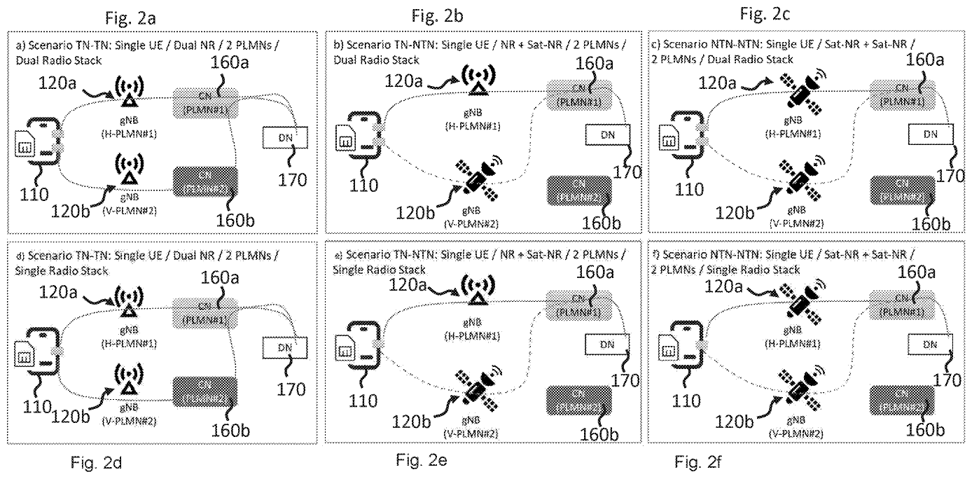

FIGS. 2a-f show schematic diagrams illustrating different scenarios for dual radio support of a UE 110 according to an embodiment by entities of a home PLMN 160a and entities of a visiting PLMN 160b.

As used herein, a UE 110 having Dual New Radio, DNR, capability (herein also referred to as Dual Radio, DR, capability) may be a UE 110 that is configured to be registered and/or connected and/or served simultaneously by two access nodes 120a, b of NR technology; In this case, the UE 110 may comprise two radio stacks and may be connected (e.g., in RRC_CONNECTED state) with the two access nodes 120a, b, e.g., gNBs 120a, b. Another possible scenario is the UE 110 being served by two eNBs RAT type, and/or one gNB and another gNB.

Moreover, as used herein, a UE 110 having DNR capability or DR capability) may be a UE 110 that is configured to be registered simultaneously in two mobile networks 160a, 160b with two access nodes 120a, 120b of the same RAT type (e.g., 2 gNBs 120a, b). It is out of the scope of the embodiments disclosed herein, how exactly the resources of the two mobile networks 160a, b are actually accessed via a single radio stack of the UE 110) It is assumed, however, that the UE 110 is able to maintain some level of radio control plane exchange of information with the two access nodes 120a, b of the two mobile networks 160a, b.

As illustrated in FIGS. 2a-f, embodiments disclosed herein relate to the UE 110 with DNR Capability being served by two PLMNs 160a, b, namely the home PLMN 160a and the visiting PLMN 160b. The home PLMN 160a (also referred to as HPLMN or H-PLMN) is the mobile network that is related to the UE subscription information (e.g., is the mobile operator that the UE 110 subscribed to, e.g., bought the SIM Card). The visiting PLMN 160b (or VPLMN or VPLMN) is a mobile network that can provide the connectivity services for a UE that does not have a subscription with this mobile network (also referred to as roaming scenario). As supported by the current 5GS Architecture defined by the 3GPP in TS 23.502, the traffic of a roaming UE 110 can be anchored at the HPLMN 160a. This is known as Home Routed Roaming Support. In this case, the HPLMN 160a and VPLMN 160b may exchange information to enable the UE 110 to use UP resources from both networks. In an embodiment, the UE 110 with DNR Capability may be associated with the HPLMN 160a and, when associated with the VPLMN 160a, the UE 110 may use the home routed roaming services provided by the VPLMN 160b.

Regarding the nature of the access node 120a, b of NR RAT type, it is possible that different types of networks may be involved in the support for the UE 110 with DNR capability. For instance, FIG. 2a (for a dual radio stack of the UE 110) and FIG. 2d (for a single radio stack of the UE 110) show an embodiment, where the two access nodes 120a, b are both implemented as components of Terrestrial Networks (TN). FIG. 2b (for a dual radio stack of the UE 110) and FIG. 2e (for a single radio stack of the UE 110) show an embodiment, where one of the NR RAT Types used by the UE 110 is related to a Non-Terrestrial-Network (NTN) with a NR satellite 120b providing the connectivity to the UE 110 and the other NR access node i120a s in a TN. FIG. 2c (for a dual radio stack UE 110) and FIG. 2f (for a single radio stack UE 110) show an embodiment, where both NR access nodes 120a, b are related to NTNs, i.e., two NR Satellite nodes 120a, b are providing the connectivity to the UE 110 with DNR Capability.

As will be appreciated, despite differences in the types of NR satellite, such as NR(LEO), NR(MEO), NR(GEO) or NR(OTHERSAT) as defined in TS 23.501, a NR satellite node presents the same N2 and N1 interfaces for the UE 110 and access node interaction with the core network as a terrestrial access node. Therefore, an NR satellite node exchanges the same messages and protocols used by a terrestrial gNB to communicate with the Core Network as well as enable the UE 110 and Core Network to exchange control messages.

As used herein, an “access node with (or of) NR RAT type”, such as the access nodes 120a, b illustrated in FIG. 1 and FIGS. 2a-f, may be any access node that has the capability to exchange N2 and N1 messages with the UE and/or the core network of the PLMN 160a, b. In other words, an access node of NR RAT Type, such as the access nodes 120a, b, is able to exchange the Access Network messages, such as registration request or PDU session request (e.g., as defined in the procedures of 3GPP TS 23.502). Thus, any of the following access nodes are considered according to embodiments disclosed herein as access nodes 120a, b with the same NR RAT type: a gNB access node 120a, b, i.e. a terrestrial access node 120a, b with NR RAT type; an NR satellite access node 120a, b with NR(LEO) RAT Type; an NR satellite access node 120a, b with NR(MEO) RAT Type; an NR satellite access node 120a, b with NR(GEO) RAT Type; and an NR satellite access node 120a, b with NR(OTHERSAT) RAT Type.

Thus, as will be appreciated, if the UE 110 is related to a gNB 120a via the HPLMN 160a and a NR satellite access node 120b (e.g., with any of the specific NR satellite RAT types), this is equivalent to an embodiment, where the UE 110 is related to two access nodes 120a, b of same NR RAT Type, where one access node 120a of NR RAT Type belongs to one PLMN 160a and the second access node 120b of the same NR RAT Type belongs to a different PLMN 160b.

Another clarification in this specification is related to the following wording: “UE to be able to use the two NR paths” and/or “UE being served by both HPLMN and VPLMN” (as well as variations of such wording). Whenever this wording is used, in this specification the terms “the use” and/or “being served” may be associated with one or more of the following: a) traffic of the UE uses first one path and after the other path (e.g., which may describe the concept of traffic switching); b) and/or traffic of the UE can be sent to both paths (e.g., which may be described as traffic steering); c) and/or a specific traffic flow is split and sent via both paths (e.g., which may be described as traffic splitting).

FIG. 3 shows an embodiment of a UE registration process implemented by the VPLMN 160b for the roaming UE 110 with DNR Capability that is activating and/or requesting activation and/or informing the VPLMN network 160b (e.g., the V-AMF 130b) about the intention or indication to use the DNR Capability in association with the services provided by the VPLMN 160b.

In step 1 of FIG. 3. the UE 101 is capable to determine it has the DNR Capability and to determine it has to request the registration in the VPLMN 160b to be associated with one of the possible paths to be associated with the DNR capability. Step 1 of FIG. 3 illustrates the possible initial actions to determine that a UE registration is related to a roaming UE registration, where such UE 110 has the DNR Capability. A Roaming UE-based indication of a Roaming DNR Registration can be implemented in different ways as described below.

Step 1a of FIG. 3 shows the embodiment where the UE 110 includes in the UE registration message to be sent to V-AMF 130b—via the access node with NR RAT Type with the Access Network (AN) message (e.g., the N1 message container)—the Roaming DNR Registration Indication. This embodiment of the Roaming DNR Registration Indication is referred as Option A.1 in FIG. 3. The Roaming DNR Registration Indication may be implemented by means of the definition of a new type of roaming registration. Current 5GS has different types of registration: initial registration and mobility registration. In this embodiment a new type of registration is employed, namely the roaming DNR Registration type. Based on the roaming DNR registration, the V-AMF 130b may directly determine that the UE registration request is related to the activation or verification or configuration or activation of the support for or association of the UE 110 performing dual registration (or in other words, the UE 110 with DNR Capability). In an embodiment, additionally, the Roaming DNR Registration Indication may also include the Roaming DNR Capability Information that defines information known to (or configured at or installed at) the UE 110 about its DNR Capabilities. In an embodiment, the UE 110 is configured to, i.e. capable of determining its DNR Capabilities.

Step 1b of FIG. 3 shows a further possible embodiment of the Roaming DNR Registration Indication (referred as Option A.2 in step 1b of FIG. 3), wherein the Roaming DNR Registration Indication is implemented by means of a new UE capability information, namely the Roaming DNR Capability Information. This capability (i.e. capability information) can be implemented in any of the following ways: (a) as a new standalone container in the registration request AN message sent by the UE 110; and/or (b) be comprised in a container (or dataset or fields or segments) of the registration request message, such as (b1) UE Radio Capability extended with Roaming DNR Capability Information or (b2) UE MM Core Network Capability extended with Roaming DNR Capability Information.

Step 1c of FIG. 3 illustrates a further embodiment, where the UE 110 sends a normal registration request to the V-AMF 130b. Based on the UE information within the received registration message, the V-AMF 130b is able to determine whether the registration request from the roaming UE 110 is related to a Roaming DNR Registration Indication associated with the roaming UE 110. The V-AMF 130b may determine this in one or more of the following ways.

The V-AMF 130b may, for instance, be configured to extract the UE identification, RAT access type, HPLMN and VPLMN information from the registration information, and compare the extracted information with the VPLMN DNR Support Configuration. In this way the V-AMF 130b is able to determine that the registration request from the UE 110 is further related to the Roaming DNR Registration indication.

In an embodiment, the base station 120b, e.g. gNB 120b of the VPLMN 160b or VPLMN access node 120b of NR RAT type (e.g., it could be also a satellite access node that is capable of operating with the same NR signaling as a terrestrial gNB, e.g., uses the same access network messages to interact with the 5G core network) receives the registration request from the UE 110, selects the V-AMF 130b, and sends the registration request (with the Roaming DRN Registration indication-e.g., the Roaming DNR Registration Type and optionally the Roaming DNR Capability Information-as per step 1a above or without as per step 1b above) encapsulated in a N2 message container to the selected V-AMF 130b. These interactions between the access node 120b and the V-AMF 130b are indicated by the solid circle in step 1 of FIG. 3.

In step 2 of FIG. 3, the V-AMF 130b determines whether DNR Capability for the roaming UE 110 requesting the registration in the VPLMN network is allowed and/or can be supported and/or if the roaming UE 110 with DNR Capability can be associated with the VPLMN 160b (e.g., being registered at the VPLMN 160b). To this end, in an embodiment, the V-AMF 130b may be configured to operate in the following way. The V-AMF 130b may be configured with the VPLMN DNR Support configuration and the V-AMF 130b may use the information enclosed in the VPLMN DNR Support configuration for comparing with (or based on VPLMN DNR Support configuration the V-AMF 130b makes this comparison with) information received from the UE 110 requesting the registration at the VPLMN 160b, For instance, the V-AMF 130b may compare the UE identification, access network RAT, HPLMN identification comprised in the registration request with the information comprised in the VPLMN DNR support configuration. If there is a match between this information, the V-AMF 130b may determine that the DNR Capability can be supported for and/or allowed and/or activated and/or provided to the roaming UE 110 at the VPLMN 160b.

In case the V-AMF 130b determines in step 2 of FIG. 3 that the DNR Capability is not allowed and/or not supported for the registering roaming UE 110, the V-AMF 130b will execute step 4 and skip step 3 of FIG. 3.

Based on the received information associated with the UE registration request, the V-AMF 130b determines the Roaming DNR Registration Information in step 3 of FIG. 3.

If the Roaming DNR Registration Indication is implemented in accordance with step 1a (referred to as Option A.1) of FIG. 3 (as described above), the V-AMF 130b checks the type of registration. If the type of registration is Roaming DNR Registration Type, the V-AMF 130b determines that a Roaming DNR Registration Information needs to be defined and/or created and/or configured, and such Roaming DNR Registration Information is related to the registration process of the roaming UE 110 in the VPLMN 160b which is described and/or represented and/or indicated by the received registration request from the UE 110. The V-AMF 130b stores the association of the roaming UE identification (e.g., the SUPI of the UE 110) with the information received in the Roaming DNR Registration Indication. For instance, this association can be stored together with the UE context at the V-AMF 130b. In this alternative embodiment, the Roaming DNR Registration information is equivalent to the combination of (or association of or comprises) the Roaming DNR Registration type and optionally the Roaming DNR Capability information. The V-AMF 130b may optionally extend the initial Roaming DNR Capability Information received from the UE 110 with any of the following extra fields: HPLMN identification, identification of the access node 120b of NR RAT Type serving the UE 110 in the VPLMN 160b, description and/or identification of the region and/or area and/or location of the VPLMN 160b, where the UE 110 requested the registration for the VPLMN 160b. This extended information may be already part of the UE registration request and/or based on V-AMF configurations. Examples of such configuration can be any of the following: VPLMN DNR support configuration, or internal or local V-AMF information, e.g., the V-AMF 130b may use the cell ID from the UE 110 indicated in the registration message in order to derive the area and/or location in terms of geo-coordinates or any other localization format based on its internal mapping configurations of cell ID to localization information.

If the Roaming DNR Registration Indication is implemented in accordance with step 1b (referred to as Option A.2) of FIG. 3 (as described above), the V-AMF 130b based on the received UE registration request from the UE 110, verifies whether the received registration request comprises a Roaming DNR Registration Indication for the UE 110. In this embodiment, the V-AMF 130b may check either whether there is a Roaming DNR Capability container, or if the UE Radio Capability information (and/or container) comprises the Roaming DNR Capability Information, or if the UE MM Core Network Capability comprises the Roaming DNR Capability Information. If the Dual NR UE Capable information is present in the Roaming DNR Capability Indication (e.g., if implemented as an enumeration or a flag, the inclusion of the flag in the message is an indication that the UE 110 has the DNR Capability, if it is implemented as Boolean, and if the Dual NR UE Capable information is set to true, this means the UE 110 has the DNR Capability), the V-AMF 130b determines that a Roaming DNR Registration Information needs to be defined and/or created and/or configured and that such DNR Registration Information is related to the registration process of the roaming UE 110 in the VPLMN 160b, which is described and/or represented and/or indicated by the received registration request from the UE 110. The V-AMF 130b stores the association of the roaming UE identification (e.g., SUPI) with the information received in the Roaming DNR Registration Indication (i.e., the DNR Capability Information). For instance, this association may be stored together with the UE context at the V-AMF 130b. In this alternative embodiment, the Roaming DNR Registration information is equivalent to the Roaming DNR Capability information. The V-AMF 130b optionally may extend the initial Roaming DNR Capability Information received from the UE 110 with any of the following extra fields: VPLMN identification, identification of the access node 120b of NR RAT Type serving the UE 110 in the VPLMN 160b, description and/or identification of the region and/or area and/or location at the VPLMN 160b where the UE 110 requested the registration for the HPLMN 160a. This extended information may be already part of the UE registration request and/or based on V-AMF configurations (e.g., the V-AMF 130b may use the cell ID from the UE 110 indicated in the registration message in order to derive the area and/or location in terms of geocoordinates or any other localization format based on its internal mapping configurations of cell ID to localization information).

If the Roaming DNR Registration Indication is implemented in accordance with step 1c of FIG. 3 (as described above), the V-AMF 130b may determine the Roaming DNR Registration Information using the same mechanisms as described above in the context of Options A.1 (step 1a) and A.2 (step 1b).

If the V-AMF 130b determines in step 2 of FIG. 3 that the roaming UE 110 with the DNR Capability is not allowed to and/or cannot be supported and/or if the roaming UE 110 with DNR Capability cannot be associated with the VPLMN 130b (e.g., being already registered at the VPLMN 130b), the V-AMF 130b in step 4 of FIG. 3 sends a registration response with an error indication and optionally includes a cause of the registration rejection, for instance, an indication of no support for DNR Capability by the VPLMN 160b. In an embodiment, the error indication provided by the V-AMF 130b to the UE 110 may be any of the following cases: (a) no support for the UE 110; (b) no support for the UE 110 with DNR Capability for the VPLMN 160b; (c) or no support for the UE 110 with the DNR Capability for the VPLMN 160b with the indicated parametrization included in the information exchanged between the V-AMF 130b and the H-UDM 140. As will be appreciated, the wording “no support” could also be a synonym of “not available”, “not to be activated”, “not allowed”.

As will be described in more detail in the following, embodiments disclosed herein provide at least two possible options for the V-AMF 130b to interact with the appropriate entity (or entities) of the HPLMN 160a in order to verify and/or determine and/or confirm whether the roaming UE 110 is allowed by the HPLMN 160a to use the DNR Capability at the VPLMN 160b and/or the roaming UE 110 with DNR Capability is allowed to be associated with the VPLMN 160b and/or allowed to have support for the DNR Capability at the VPLMN 160b. The embodiment referred to as option A.3 in FIG. 3 defines the interactions between the V-AMF 130b and the

H-UDM 140 using the service Nudm_SDM_Get request exposed by the H-UDM 140, while the embodiment referred to as option A.4 in FIG. 3, defines the interactions between the V-AMF 130b and the H-UDM 140 using the service Nudm_UECM_Registration request exposed by the H-UDM 140.

For option A.3 in step 5 of FIG. 3, the V-AMF 130b invokes the Nudm_SDM_Get service operation from the H-UDM 140 in order to retrieve UE related information from the HPLMN 160a (e.g., UE subscription related information and/or HPLMN policies for the UE 110 and/or HPLMN configurations for the roaming UE 110). The UE related information may be, for instance, any of the following types of information (also defined in TS 23.502 Clause 5.2.3.3.1): Access and Mobility Subscription data, Slice Selection Subscription data, Session Management Subscription data. In this embodiment the V-AMF 130b includes in the Nudm_SDM_Get request message (e.g., as input parameter) the Roaming DNR Registration Information.

For option A.3 in step 6 of FIG. 3, based on the received information from the V-AMF 130b, the H-UDM 140 may determine whether the roaming UE 110 with the indicated VPLMN 160b (e.g., the roaming UE 110 that is performing the registration process at the VPLMN 160b) is allowed to be supported and/or is allowed to be associated and/or is allowed to use and/or is allowed to activate the DNR Capability at the VPLMN 160b. As will be appreciated, it is also possible that the H-UDM 140 may use further information for this determination.

For option A.3 in step 7 of FIG. 3, the H-UDM 140 sends to the V-AMF 130b the response of the Nudm_SDM_Get service operation including an indication of error in case the roaming UE 110 is not allowed to be associated with (and/or use and/or have the support for) the DNR Capability at the VPLMN 160b (step 7a of FIG. 3). In this case, the H-UDM 140 may also include a cause for the error such as a lack of DNR support at the HPLMN for any of the following cases: (a) for the UE 110; (b) for the UE with DNR Capability for the VPLMN 160b; (c) or for the UE 110 with the DNR Capability for the VPLMN 160b with the indicated parametrization included in the information exchanged between the V-AMF 130b and the H-UDM 140. It is also possible that the indication of error is itself any of the listed possibilities (a), (b), and (c) described above.

In case the H-UDM 140 determines the roaming UE 110 is allowed to be associated with (and/or use and/or have the support for) the DNR Capability at the VPLMN 160b, the H-UDM 140 sends to the V-AMF 130b via the response of the Nudm_SDM_Get service operation (step 7b of FIG. 3) the Roaming DNR Support Indication, which may simply confirm (e.g., with a flag parameter) that the DNR Capability is allowed to be associated with the UE 110 at the VPLMN 160b, or it may comprise further information with details or configurations related to the H-PLMN 160a about the DNR Capability information. For instance, it may be possible that the Roaming DNR Registration Information sent by the V-AMF 130b contained a set of parameters and their values considering the information available at VPLMN 160b, The H-UDM 140 may be able to update such information and send the updated information as part of the Roaming DNR Support Indication.

For option A.3 in step 8 of FIG. 3, the V-AMF 130b registers itself as the AMF serving the UE 110 at the VPLMN 160b by using the Nudm_UECM_Registration service operation provided by the H-UDM 140.

For option A.4 in step 5 of FIG. 3, the V-AMF 130b invokes the Nudm_SDM_Get service operation provided by the H-UDM 140 in order to retrieve UE related information from the HPLMN 160a (e.g., UE subscription related information and/or HPLMN policies for the UE 110 and/or HPLMN configurations for the roaming UE 110). This UE related information may comprise, for instance, any of the following information types (as defined in TS 23.502 Clause 5.2.3.3.1): Access and Mobility Subscription data, Slice Selection Subscription data, Session Management Subscription data.

For option A.4 in step 6 of FIG. 3, the V-AMF 130b registers itself as the AMF serving the UE 110 at the VPLMN 160b using the Nudm_UECM_Registration service operation provided by the H-UDM 140. In this embodiment the V-AMF 130b may include in the Nudm_UECM_Registration service operation request (e.g., as input parameter) the Roaming DNR Registration Information.

For option A.4 in step 7 of FIG. 3, based on the received information from the V-AMF 130b, the H-UDM 140 is able to determine whether the roaming UE 110 with the indicated VPLMN 160b (e.g., the roaming UE 110 that is performing the registration process at the VPLMN 160b) is allowed to be supported and/or is allowed to be associated and/or is allowed to use and/or is allowed to activate the DNR Capability at the VPLMN 160b. As will be appreciated, it is also possible that the H-UDM 140 may use further information for this determination.

For option A.4 in step 8 (a and b) of FIG. 3, the H-UDM 140 sends to the V-AMF 130b the response of the Nudm_UECM_Registration service operation including an indication of error in case the roaming UE 110 is not allowed to be associated with (and/or use and/or have the support for) the DNR Capability at the VPLMN 160b (step 8a of FIG. 3). In this case, the H-UDM 140 may include a cause for the error such as a lack of DNR support at the HPLMN 160a for any of the following cases: (a) for the UE 110; (b) for the UE 110 with DNR Capability for the VPLMN 160b; or (c) for the UE 110 with the DNR Capability for the VPLMN 160b with the indicated parametrization included in the information exchanged between the V-AMF 130b and the H-UDM 140. It is also possible that the indication of error is itself any of the listed possibilities (a), (b), and (c) described above.

In case the H-UDM 140 determines that the roaming UE 110 is allowed to be associated with (and/or use and/or have the support for) the DNR Capability at the VPLMN 160b, the H-UDM 140 sends to the V-AMF 130b via the response of the Nudm_UECM_Registration service operation (Step 8b) the Roaming DNR Support Indication, which may simply confirm (e.g., with a flag parameter) that the DNR Capability is allowed to be associated with the UE 110 at the VPLMN 160b, or it may comprise further information with details or configurations related to the H-PLMN 160a about the DNR Capability information. For instance, the Roaming DNR Registration Information sent by the V-AMF 130b may contain a set of parameters and their values considering the information available at the VPLMN 160b. The H-UDM 140 may be able to update such information and send the updated information as part of the Roaming DNR Support Indication.

If the V-AMF 130b receives any indication of error in case the roaming UE 110 is not allowed to be associated with (and/or use and/or have the support for) the DNR Capability at the VPLMN 160a (as determined in step 7a according to option A.3 or step 8a according to option A.4), the V-AMF 130b sends in step 9 of FIG. 3 a registration response with an error indication and optionally includes a cause of the registration rejection an indication of no support for DNR Capability at the VPLMN 160b. According to an embodiment, the error indication provided by the V-AMF 130b to the UE 110 may comprise any of the following indications: (a) no support for the UE 110; (b) no support for the UE 110 with DNR Capability for the VPLMN 160b; or (c) no support for the UE 110 with the DNR Capability for the VPLMN 160b with the indicated parametrization included in the information exchanged between the V-AMF 130b and the H-UDM 140. The wording “no support” could also be a synonym of “not available”, “not to be activated”, “not allowed”.

In step 10 of FIG. 3 the V-AMF 130b confirms that the roaming UE 110 with the DNR Capability is allowed to be associated with (and/or has the support for and/or is able to use and/or can activate and/or can use and/or be registered with) the VPLMN 160b (e.g., the fact that the V-AMF 130b receives the Roaming DNR support Indication may in itself be a confirmation that the HPLMN 160a allows the roaming UE 110 with DNR Capability to be associated with the VPLMN 160b). Moreover, the V-AMF 130b may further store the association of the roaming UE identification (e.g., SUPI) with the Roaming DNR Support Indication received from H-UDM 140. For instance, this association can be stored together with the UE context at the AMF 130b. The V-AMF 130b based on the Roaming DNR Support Indication may update stored parameters relating to the roaming UE 110 and/or to the supported and/or allowed information defining the DNR Capability for the UE 110 with the VPLMN 160b and HPLMN 160a. Example of such updates are, if the V-AMF 130b had stored that the UE 110 with DNR Capability was allowed to activate and/or use and/or be associated with the DNR Capability in regions “A, B” of the VPLMN network 160b and the Roaming DNR Support Indication indicates a different information (e.g., region “A”), the V-AMF 130b may update the stored association information of Roaming UE with DNR Capability (e.g., the UE Context information at the V-AMF 130b) including the new parameters and/or their values (or substituting existing parameters and/or their values with the new ones received in the Roaming DNR Support Indication). Based on any of the information available to the V-AMF 130b related to the DNR Capability of the roaming UE 110 (e.g., any of the following: the roaming DNR Registration Indication, the roaming DNR Registration Information, the roaming DNR Support Indication, VPLMN DNR support configuration) the V-AMF 130b determines the Roaming DNR Information and sends this information to the UE 110, for instance as part of the registration acceptance message.

FIG. 4 shows a variant of the embodiment of FIG. 3, wherein the H-UDM is the entity determining that the roaming UE 110 is allowed to activate and/or use and/or be associated with DNR Capability at the VPLMN network 160b.

In step 1 of FIG. 4, the roaming UE 110 triggers the Registration procedure at the VPLMN 160b, by sending a registration request to the core network of the VPLMN 160b. The Registration request is sent to the RAN access node 120b associated with the UE 110 and the RAN access node 120b selects the appropriate V-AMF 130b to handle the roaming UE registration request. According to embodiments disclosed herein, the V-AMF 130b may be configured to operate in at least two different ways with the proper entity (or entities) of the HPLMN 160a so that the HPLMN 160a may identify that the DNR Capability is to be associated with the roaming UE 110 at the VPLMN 160b. An option B.1 shown in FIG. 4 defines interactions between the V-AMF 130b and the H-UDM 140 using the service Nudm_SDM_Get request provided by the H-UDM 140. The alternative option B.2 shown in FIG. 4 defines interactions between the V-AMF 130b and the H-UDM 140 using the service Nudm_UECM_Registration request provided by the H-UDM 140.

For option B.1 in step 2 of FIG. 4, the V-AMF 130b invokes the Nudm_SDM_Get service operation from the H-UDM 140 in order to retrieve UE related information from the HPLMN 160a (e.g., UE subscription related information and/or HPLMN policies for the UE 110 and/or HPLMN configurations for the roaming UE 110). The UE related information may comprise any of the following (as defined in TS 23.502 Clause 5.2.3.3.1): Access and Mobility Subscription data, Slice Selection Subscription data, Session Management Subscription data.

For option B.1 in step 3 of FIG. 4, based on the received information from the V-AMF 130b and HPLMN DNR Support Configuration available at the H-UDM 140, the H-UDM 140 is configured to determine whether the roaming UE 110 with the indicated VPLMN 160b (e.g., the roaming UE 110 that is performing the registration process at the VPLMN 160b) is allowed to be supported and/or is allowed to be associated and/or is allowed to use and/or is allowed to activate the DNR Capability at the VPLMN 160b. The HPLMN DNR Support Configuration may be stored at H-UDM 140 or the H-UDM 140 may be configured to retrieve this information from further entities in the HPLMN 160a (e.g., by retrieving subscription information from a H-UDR of the HPLMN 160).

For option B.1 in step 4 of FIG. 4, the H-UDM 140 sends to the V-AMF 130b the response of the Nudm_SDM_Get service operation including an indication of error in case the roaming UE 110 is not allowed to be associated with (and/or use and/or have the support for) the DNR Capability at the VPLMN 160b. In this case, the H-UDM 140 may also include a cause for the error such as a lack of DNR support at the HPLMN 160a for any of the following cases: (a) for the UE 110 or (b) for the UE 110 with DNR Capability for the VPLMN 160b; or (c) for the UE 110 with the DNR Capability for the VPLMN 160b with the indicated parametrization included in the information exchanged between the V-AMF 130b and the H-UDM 140. It is also possible that the indication of error is itself any of the listed possibilities (a), (b), and (c) described above.

For option B.1 in step 5 of FIG. 4, in case the H-UDM 140 determines that the roaming UE 110 is allowed to be associated with (and/or use and/or have the support for) the DNR Capability at the VPLMN 160b, the H-UDM 140 sends to the V-AMF 130b via the response of the Nudm_SDM_Get service operation the Roaming DNR Support Indication, which may simply confirm (e.g., with a flag parameter) that the DNR Capability is allowed to be associated with the UE 110 at the VPLMN 160b, or it may comprise further information with details or configurations related to the H-PLMN 160a about the DNR Capability information. For instance, the Roaming DNR Registration Information sent by the V-AMF 130b may contain a set of parameters and their values considering the information available at the VPLMN 160b. The H-UDM 140 may be configured to update such information and send the updated information as part of the Roaming DNR Support Indication.

For option B.1 in step 6 of FIG. 4, the V-AMF 130b registers itself as the AMF serving the UE 110 at the VPLMN 160b using the Nudm_UECM_Registration service operation provided by the H-UDM 140.

For option B.2 in step 2 of FIG. 4, the V-AMF 130b invokes the Nudm_SDM_Get service operation from the H-UDM 140 in order to retrieve UE related information from the HPLMN 160a (e.g., UE subscription related information and/or HPLMN policies for the UE 110 and/or HPLMN configurations for the roaming UE 110). The UE related information may comprise any of the following (as defined in TS 23.502 Clause 5.2.3.3.1) Access and Mobility Subscription data, Slice Selection Subscription data, Session Management Subscription data. The H-UDM 140 sends the requested information to the V-AMF 130b.

For option B.2 in step 3 of FIG. 4, the V-AMF 130b registers itself as the AMF serving the UE 110 at the VPLMN 160b using the Nudm_UECM_Registration service operation provided by the H-UDM 140.

For option B.2 in step 4 of FIG. 4, based on the received information from the V-AMF 130b and the HPLMN DNR Support Configuration available at the H-UDM 140, the H-UDM 140 is configured to determine whether the roaming UE 110 with the indicated VPLMN 160b (e.g., the roaming UE 110 that is performing the registration process at the VPLMN 160b) is allowed to be supported and/or is allowed to be associated and/or is allowed to use and/or is allowed to activate the DNR Capability at the VPLMN 160b. The HPLMN DNR Support Configuration may be stored at the H-UDM 140 or the H-UDM 140 may be configured to retrieve this information from further entities in the HPLMN 160a (e.g., by retrieving subscription information from a H-UDR of the HPLMN 160a).

For option B.2 in step 5 of FIG. 4, the H-UDM 140 sends to the V-AMF 130b the response of the Nudm_UECM_Registration service operation including an indication of error in case the roaming UE 110 is not allowed to be associated with (and/or use and/or have the support for) the DNR Capability at the VPLMN 160b. In this case, the H-UDM 140 may also include a cause for the error such as a lack of DNR support at the HPLMN 160a for any of the following cases: (a) for the UE 110; (b) for the UE 110 with DNR Capability for the VPLMN 160b; or (c) for the UE 110 with the DNR Capability for the VPLMN 160b with the indicated parametrization included in the information exchanged between the V-AMF 130b and the H-UDM 140. It is also possible that the indication of error is itself any of the listed possibilities (a), (b), and (c) described above.

For option B.2 in step 6 of FIG. 4, in case the H-UDM 140 determines that the roaming UE 110 is allowed to be associated with (and/or use and/or have the support for) the DNR Capability at the VPLMN 160b, the H-UDM 140 sends to the V-AMF 130b via the response of the Nudm_UECM_Registration service operation the Roaming DNR Support Indication, which may simply confirm (e.g., with a flag parameter) that the DNR Capability is allowed to be associated with the UE 110 at the VPLMN 160b, or it may comprise further information with details or configurations related to the H-PLMN 160a about the DNR Capability information. For instance, the Roaming DNR Registration Information sent by the V-AMF 130b may contain a set of parameters and their values considering the information available at the VPLMN 160b. The H-UDM 140 may be configured to update such information and send the updated information as part of the Roaming DNR Support indication.

In step 7 of FIG. 4, based on the Roaming DNR Support Indication and/or the VPLMN DNR Support Configuration, the V-AMF 130b determines whether DNR Capability for the roaming UE 110 requesting the registration in the VPLMN network 160b is allowed and/or can be supported and/or if the roaming UE 110 with DNR Capability can be associated with the VPLMN 160b (e.g., being registered at the VPLMN 160b). An embodiment of the V-AMF 130b for performing this determination is described in the following. The V-AMF 130b may be configured with the VPLMN DNR Support configuration. The V-AMF 130b may use the information from the Roaming DNR Support Indication and/or VPLMN DNR Support configuration for comparing this information (or based on the VPLMN DNR Support configuration the V-AMF 130b compares) with information received from the UE 110 requesting the registration at the VPLMN 160b. For instance, the V-AMF 130b may compare the UE identification, access network RAT, HPLMN identification comprised in the registration request with the information contained in the Roaming DNR Support Indication and/or the VPLMN DNR support configuration. If there is a match between this information, the V-AMF 130b determines that the DNR Capability can be supported and/or allowed and/or activated and/or provided for the roaming UE 110 at the VPLMN 160b.

If the V-AMF 130b receives any indication of error in case the roaming UE 110 is not allowed to be associated with (and/or use and/or have the support for) the DNR Capability at the VPLMN 160b (as determined in step 4 of Option B.1 or step 5 of Option B.2) and/or the V-AMF 130b determines in step 7 of FIG. 4 that the roaming UE 110 is not allowed to be associated with (and/or use and/or have the support for) the DNR Capability at the VPLMN 160b, the V-AMF 130b in step 8a of FIG. 4 sends a registration response with an error indication, which may optionally include a cause of the registration rejection, such as an indication of no support for DNR Capability at the VPLMN 160b. In an embodiment, the error indication provided by the V-AMF 130b to the UE 110 may be any of the following cases: (a) no support for the UE 110 at the VPLMN 160b and/or the HPLMN 160a; (b) no support for the UE 110 with DNR Capability for the VPLMN 160b; or (c) or no support for the UE 110 with the DNR Capability for the VPLMN 160b with the indicated parametrization included in the information exchanged between the V-AMF 130b and the H-UDM 140. The wording “no support” could also be a synonym of “not available”, “not to be activated”, “not allowed”.

In case, the V-AMF 130b has registered itself as the serving NF for the roaming UE 110, the V-AMF 130b may send in step 8b of FIG. 4 a de-registration message via Nudm_ UECM_DeRegistration to the H-UDM 140 with an indication of error and/or no support for DNR Capability for the roaming UE 110 at the VPLMN 160b.

If the V-AMF 130b confirms that the roaming UE 110 with the DNR Capability is allowed to be associated with (and/or has the support for and/or is able to use and/or can activate and/or can use and/or be registered with) the VPLMN 160b (e.g., the fact that the V-AMF 130b receives the Roaming DNR support Indication may be in itself the confirmation that the HPLMN 160a allows the roaming UE 110 with DNR Capability to be associated with the VPLMN 160b), the V-AMF 130b may store the association of the roaming UE identification (e.g., SUPI) with the Roaming DNR Support Indication received from the H-UDM 140. For instance, this association may be stored together with the UE context by the V-AMF 130b. Moreover, the V-AMF 130b based on the Roaming DNR Support Indication may update stored parameters relating the roaming UE 110 to the supported and/or allowed information defining the DNR Capability for the UE 110 with the VPLMN 160b and the HPLMN 160a. Based on any of the information available to the V-AMF 130b related to the DNR Capability of the roaming UE 110 (e.g., any of the following: the Roaming DNR Support Indication, VPLMN DNR support configuration), the V-AMF 130b determines the Roaming DNR Information and sends this information in step 9 of FIG. 4 to the UE 110, for instance as part of the registration acceptance message.

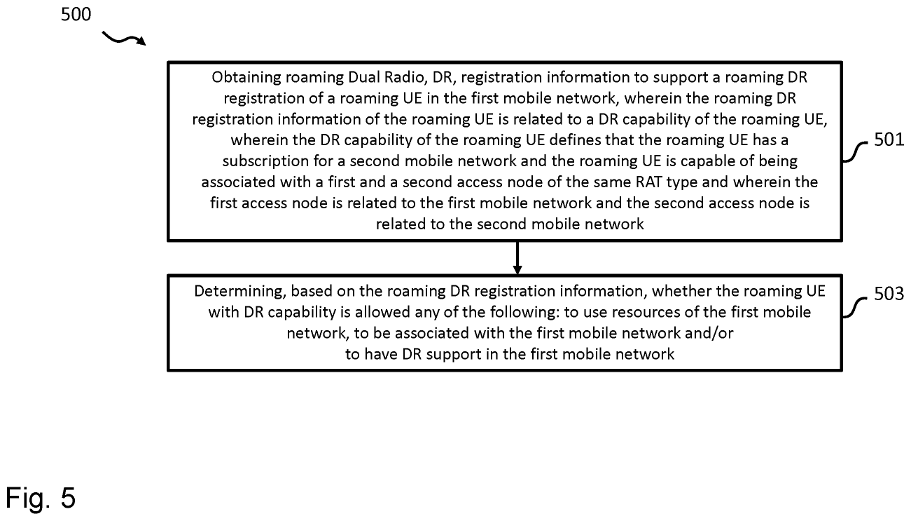

FIG. 5 is a flow diagram illustrating a method 500 for operating the first control plane entity 130b, in particular V-AMF 130b, for the first mobile network 160b, in particular VPLMN 160b. The method 500 comprises a step 501 of obtaining roaming Dual Radio, DR, registration information to support a roaming DR registration of the UE 110 in the first mobile network 160b, in particular VPLMN 160b. The roaming DR registration information of the roaming UE 110 is related to a DR capability of the roaming UE 110, wherein the DR capability of the roaming UE 110 defines that the roaming UE 110 has a subscription for a second mobile network 160a, in particular HPLMN 160a, and the roaming UE 110 is capable of being associated with a first and a second access node 120a, b of the same radio access technology, RAT, type and wherein the first access node 120b is related to the first mobile network 160b, in particular VPLMN 160b, and the second access node 120a is related to the second mobile network 160a, In particular HPLMN 160a. Moreover, the method 500 comprises a step 503 of determining, based on the roaming DR registration information, whether the roaming UE 110 with DR capability is allowed any of the following: to use resources of the first mobile network 160b, in particular VPLMN 160b, and/or to have DR support in the first mobile network 160b, in particular VPLMN 160b.

The method 500 illustrated in FIG. 5 can be performed by the V-AMF 130b according to an embodiment. Thus, further features of the method 500 result directly from the functionality of the V-AMF 130b as well as the different embodiments thereof described above and below.

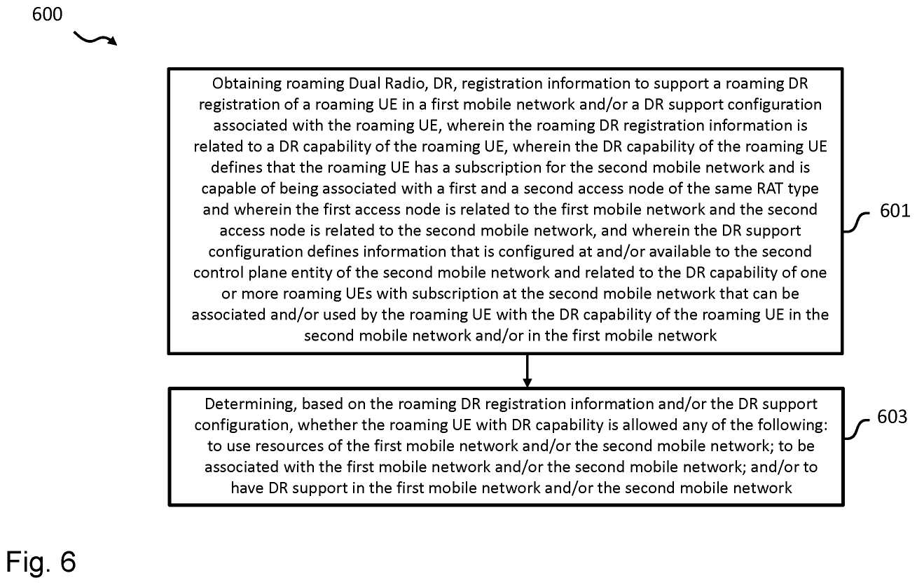

FIG. 6 is a flow diagram illustrating a method 600 for operating the second control plane entity 140, in particular H-UDM 140, for the second mobile network 160a, in particular HPLMN 160a. The method 600 comprises a step 601 of obtaining roaming Dual Radio, DR, registration information to support a roaming DR registration of the roaming UE 110 in the first mobile network 160b, in particular VPLMN 160b, and/or a DR support configuration associated with the roaming UE 110. The roaming DR registration information is related to a DR capability of the roaming UE 110, wherein the DR capability of the roaming UE 110 defines that the roaming UE 110 has a subscription for the second mobile network 160b, in particular HPLMN 160b, and is capable of being associated with a first and a second access node 120a, b of the same RAT type and wherein the first access node 120b is related to the first mobile network 160b, in particular VPLMN 160b, and the second access node 120a is related to the second mobile network 160a, in particular HPLMN 160a. The DR support configuration defines information that is configured at and/or available to the second control plane entity 140, in particular H-UDM 140, of the second mobile network 160b, in particular HPLMN 160b, and related to the DR capability of one or more roaming UEs 110 with subscription at the second mobile network 160b, in particular the HPLMN 160b, that can be associated and/or used by the roaming UE 110 with the DR capability of the roaming UE 110 in the second mobile network 160b, in particular HPLMN 160b, and/or in the first mobile network 160a, in particular the VPLMN 160a. Moreover, the method 600 comprises a step 603 of determining, based on the roaming DR registration information and/or the DR support configuration, whether the roaming UE 110 with DR capability is allowed any of the following: to use resources of the first mobile network 160b, in particular VPLMN 160b, and/or the second mobile network 160a, in particular HPLMN 160a; to be associated with the first mobile network 160b, in particular VPLMN 160b, and/or the second mobile network 160a, in particular HPLMN 160a; and/or to have DR support in the first mobile network 160b, in particular VPLMN 160b, and/or the second mobile network 160a, in particular HPLMN 160a.

The method 600 illustrated in FIG. 6 can be performed by the H-UDM 140 according to an embodiment. Thus, further features of the method 600 result directly from the functionality of the H-UDM 140 as well as the different embodiments thereof described above and below.

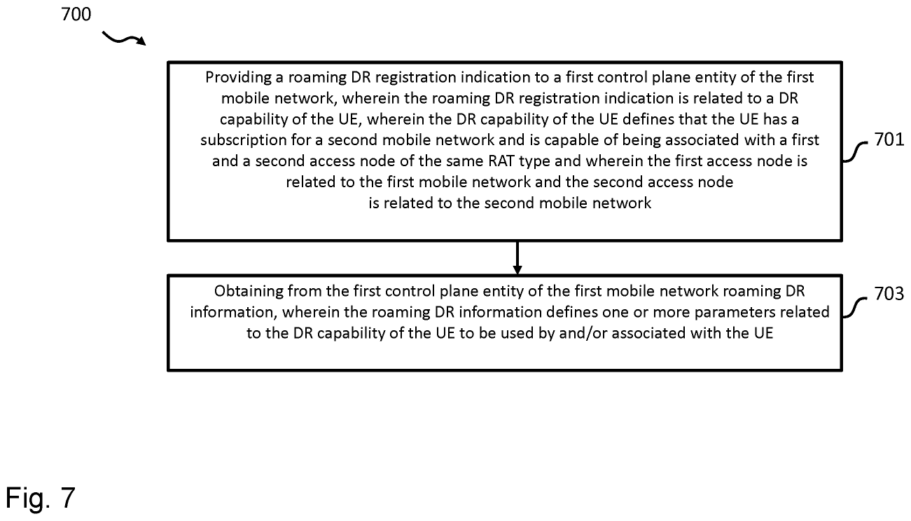

FIG. 7 is a flow diagram illustrating a method 700 for operating the UE 110. The method 700 comprises a step 701 of providing a roaming DR registration indication to the first control plane entity 130b, in particular the V-AMF 130b, of the first mobile network 160b, in particular VPLMN 160b. The roaming DR registration indication is related to a DR capability of the UE 110, wherein the DR capability of the UE 110 defines that the UE 110 has a subscription for the second mobile network 160a, in particular HPLMN 160a, and is capable of being associated with a first and a second access node 120a, b of the same radio access technology, RAT, type and wherein the first access node 120b is related to the first mobile network 160b, in particular VPLMN 160b, and the second access node 120a is related to the second mobile network 160a, in particular VPLMN 160b. Moreover, the method 700 comprises a step 703 of obtaining from the first control plane entity 130b, in particular V-AMF 130b, of the first mobile network 160b, in particular VPLMN 160b, roaming DR information, wherein the roaming DR information defines one or more parameters related to the DR capability of the UE 110 to be used by and/or associated with the UE 110.

The method 700 illustrated in FIG. 7 can be performed by the UE 110 according to an embodiment. Thus, further features of the method 700 result directly from the functionality of the UE 110 as well as the different embodiments thereof described above and below.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely a logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the disclosure may be integrated into one processing unit, or each of the units may exist alone physically, or two or more units may be integrated into one unit.

1. A first control plane entity (130b) of a first mobile network (160b), wherein the first control plane entity (130b) is configured to:
obtain roaming Dual Radio(DR), registration information to support a roaming DR registration of a roaming user equipment(UE) (110) in the first mobile network (160b), wherein the roaming DR registration information of the roaming UE (110) is related to a DR capability of the roaming UE (110), wherein the DR capability of the roaming UE (110) defines that the roaming UE (110) has a subscription for a second mobile network (160a) and the roaming UE (110) is capable of being associated with a first and a second access node (120a, b) of the same radio access technology(RAT) type and wherein the first access node (120b) is related to the first mobile network (160b) and the second access node (120a) is related to the second mobile network (160a); and
determine, based on the roaming DR registration information, whether the roaming UE (110) with DR capability is allowed any of the following: to use resources of the first mobile network (160b), to be associated with the first mobile network (160b) and/or to have DR support in the first mobile network (160b).

2. The first control plane entity (130b) of claim 1, wherein the first control plane entity (130b) is configured to obtain the roaming DR registration information based on any of the following:
obtaining a roaming DR registration indication, wherein the roaming DR registration indication is indicative of a request for using dual radio capability and/or support for dual radio capability;
obtaining roaming DR support information, wherein the roaming DR support Information defines at least one of: roaming dual radio Capability Information that can be supported by and/or configured for the roaming UE (110) and/or roaming dual radio Capability Information that is in use by the roaming UE (110) or that is associated with the roaming UE (110) at a given point in time, wherein the roaming dual radio Capability Information defines one or more parameters and/or one or more configurations related to the dual radio capability of the roaming UE (110);
being configured with roaming DR support configuration for the first mobile network (160b) to support the determination whether one or more roaming UE(s) (110) are associable with the DR capability of the roaming UE (110) in the first mobile network (160b), wherein the roaming DR support configuration defines the information that is configured at the first control plane entity (130b) of the first mobile network (160b) and related to the DR capability of one or more roaming UEs (110) with subscription at the second mobile network (160a) that can be associated and/or used by the roaming UE (110) with the DR capability of the roaming UE (110) in the first mobile network (160b).

3. The first control plane entity (130b) of claim 1, wherein the first control plane entity (130b) is configured to obtain the roaming DR registration indication by receiving a message comprising the roaming DR registration indication from the roaming UE (110).

4. The first control plane entity (130b) of claim 1, wherein the roaming DR registration indication further comprises:
a roaming dual radio registration type, wherein the roaming dual radio registration type indicates a type of UE registration request, wherein the type of UE registration request indicates the UE (110) requesting the registration has a subscription to the second mobile network (160a) and has the DR capability; and/or
dual radio Capability Information, wherein the dual radio Capability Information defines one or more parameters and/or one or more configurations related to the dual radio capability of the roaming UE (110).

5. The first control plane entity (130b) of claim 1, wherein the first control plane entity (130b) is configured to obtain the roaming DR support information by receiving a message comprising the roaming DR support information from a second control plane entity (140) of the second mobile network (160a).

6. The first control plane entity (130b) of claim 1, wherein, if the first control plane entity (130b) determines that the roaming UE (110) is not allowed to use resources of the first mobile network (160b) and/or to be associated with the first mobile network (160b), and/or to have DR support in the first mobile network (160b).

7. The first control plane entity (130b) of claim 1, wherein the first control plane entity (130b) is configured to send a registration rejection message to the roaming UE (110), wherein the registration rejection message comprises an indication that the cause for the registration rejection is related to a lack of DR support for the roaming UE (110) in the first mobile network (160b), wherein DR support defines that a UE (110) with DR capability is allowed to use resources from a mobile network and/or be associated with a mobile network.

8. The first control plane entity (130b) of claim 1, wherein the first control plane entity (130b) is configured to send the roaming DR registration information to a second control plane entity (140) of the second mobile network (160a).

9. The first control plane entity (130b) of claim 1, wherein the first control plane entity (130b) is further configured to receive from the second control plane entity (140) of the second mobile network (160a) information indicative of registration rejection of the roaming UE (110) related to a lack of DR support for the roaming UE (110), in case the roaming UE (110) is not allowed any of the following:
to use resources of the first mobile network (160b) and/or resources of the second mobile network (160a) for DR support,
to be associated with the first mobile network (160b) and/or the second mobile network (160a) for DR support, and/or
to have DR support in the first mobile network (160b) and/or for the second mobile network (160a).

10. The first control plane entity (130b) of claim 1, wherein the first control plane entity (130b) is configured to store a Roaming DR Registration Indication and/or Roaming DR Registration Information and/or a Roaming DR Support Indication together with a roaming UE identification.

11. The first control plane entity (130b) of claim 1, wherein the first control plane entity (130b) is further configured to provide the roaming dual radio(DR) information to the roaming UE (110), wherein the roaming dual radio information defines the one or more parameters related to the dual radio capability of the roaming UE (110) to be used by and/or associated with the roaming UE (110).

12. A second control plane entity (140) of a second mobile network (160b), wherein the second control plane entity (140) is configured to:
obtain roaming Dual Radio(DR) registration information to support a roaming DR registration of a roaming user equipment(UE) (110) in a first mobile network (160b) and/or a DR support configuration associated with the roaming UE (110), wherein the roaming DR registration information is related to a DR capability of the roaming UE (110), wherein the DR capability of the roaming UE (110) defines that the roaming UE (110) has a subscription for the second mobile network (160a) and is capable of being associated with a first and a second access node (120a, b) of the same radio access technology, RAT, type and wherein the first access node (120b) is related to the first mobile network (160b) and the second access node (120a) is related to the second mobile network (160a), and wherein the DR support configuration defines information that is configured at and/or available to the second control plane entity (140) of the second mobile network (160a) and related to the DR capability of one or more roaming UEs with subscription at the second mobile network (160b), that can be associated and/or used by the roaming UE (110) with the DR capability of the roaming UE (110) in the second mobile network (160a) and/or in the first mobile network (160b); and
determine, based on the roaming DR registration information and/or the DR support configuration, whether the roaming UE (110) with DR capability is allowed any of the following: to use resources of the first mobile network (160b) and/or the second mobile network (160a); to be associated with the first mobile network (160b) and/or the second mobile network (160a); and/or to have DR support in the first mobile network (160b) and/or the second mobile network (160a).

13. The second control plane entity (140) of claim 12, wherein the second control plane entity (140) is configured to receive the roaming DR registration information from a first control plane entity (130b) of the first mobile network (160b).

14. The second control plane entity (140) of claim 12, wherein the second control plane entity (140) is configured to send to the first control plane entity (130b) of the first mobile network information indicative of a cause of a registration rejection of the roaming UE (110), in case the roaming UE (110) is not allowed to use resources of the first mobile network (160b), to be associated with the first mobile network (160b) and/or to have DR support in the first mobile network (160b).

15. The second control plane entity (140) of claim 12, wherein the second control plane entity (140) is configured to determine roaming DR support information and to send the roaming DR support information to a first control plane entity (130b) of the first mobile network (160b).

16. A method (700) for operating a user equipment(UE) (110) for using a dual radio(DR capability in a first mobile network (160b), wherein the method (700) comprises:
providing (701) a roaming DR registration indication to a first control plane entity (130b) of the first mobile network (160b), wherein the roaming DR registration indication is related to a DR capability of the UE (110), wherein the DR capability of the UE (110) defines that the UE (110) has a subscription for a second mobile network (160a) and is capable of being associated with a first and a second access node (120a, b) of the same radio access technology, RAT, type and wherein the first access node (120b) is related to the first mobile network (160b) and the second access node (120a) is related to the second mobile network (160a); and
obtaining (703) from the first control plane entity (130b) of the first mobile network (160b) roaming DR information, wherein the roaming DR information defines one or more parameters related to the DR capability of the UE (110) to be used by and/or associated with the UE (110).
